(19) United States
(12) Patent Application Publication
(10) Pub. No.: US 2020/0015402 A1
(43) Pub. Date: Jan. 16, 2020

(54) MECHANICAL STOP FOR QUICK HITCH LATCH ENGAGEMENT

(71) Applicant: CNH Industrial America LLC, New Holland, PA (US)

(72) Inventors: Daniel J. Zurn, Horace, ND (US); John T. Rasset, Barnesville, MN (US); Nathan J. Carlson, West Fargo, ND (US); Abhijeet R. Bhalerao, Westmont, IL (US)

(73) Assignee: CNH Industrial America LLC, New Holland, PA (US)

(21) Appl. No.: 16/033,294

(22) Filed: Jul. 12, 2018

(51) Int. Cl. A01B 59/06

(52) U.S. Cl. CPC A01B 59/066

(57) ABSTRACT

A vehicle including a hitch configured to couple to an implement. The hitch includes a frame, at least one linkage supported by the frame, and at least one latch pivotally connected to the frame and connected to the at least one linkage. The at least one latch has a distal end and a projection. The at least one latch is configured for selectively rotating between an engaged position for retaining the implement and a disengaged position for releasing the implement. The hitch also includes a mechanical stop connected to the frame and positioned adjacent to the projection in the engaged position of the at least one latch such that the mechanical stop is configured for preventing a deformation of the at least one linkage.

### FIELD OF THE INVENTION

The present invention pertains to vehicles and, more specifically, to vehicles with quick hitches.

### BACKGROUND OF THE INVENTION

A three-point hitch on an agricultural vehicle, such as a tractor, is used to connect the agricultural vehicle to the implement. Generally, a three-point hitch has a pair of hitch arms which each have corresponding receiving ends, such as ball socket arrangements for receiving a respective pin of the implement. Some three-point hitches can have a quick coupling feature that allows the pins of the implement to be quickly and easily latched within respective hooked receiving ends of the three-point hitch.

A quick hitch generally includes an actuation handle, a linkage, and a latch associated with a respective hook of each hitch arm. The handles are typically positioned at the top of the hitch, the linkages may be internally disposed within the body of the hitch, and the latches may be pivotally attached to the hitch near the hooks so that the latches can rotate to selectively secure the pins of the implement within the hooks. Each linkage is in the form of a small diameter rod which interconnects a respective handle with a respective latch. The linkages transmit the movement of the handles to each latch. In operation, a user can selectively engage or disengage the implement by actuating the quick-hitch handles to move the linkages, which then correspondingly rotate the latches to selectively obstruct each opening to the hooks in order to retain or release the implement.

Quick hitches can be beneficial in order to quickly couple the implement and the agricultural vehicle together. Yet, a quick hitch can become deformed during use and may then cause the latches to interfere the with the release and/or engagement of the implement. For instance, when the implement is coupled to the agricultural vehicle during transportation or fieldwork the forces acting on latches, such as vertical or compressive loads from the implement acting on the latches, can bend the linkages. The deformed linkages do not allow the latches to fully rotate into and out of the engaged and disengaged positions such that the latches then partially block the opening of the hooks and interfere with the (dis)engagement of the implement.

What is needed in the art is a cost-effective and efficient quick hitch for an agricultural vehicle which can prevent deformation of the linkages.

### SUMMARY OF THE INVENTION

In one exemplary embodiment formed in accordance with the present invention, there is provided a quick hitch that includes latches and mechanical stops. The profile of the latches allows the latch to contact the respective mechanical stops in order to prevent any load from the implement acting onto the latches to transfer onto the linkages. A respective latch contacting a respective mechanical stop allows the mechanical stop to receive the load instead of a respective latch, and thereby the mechanical stop prevents deformation of the linkage.

In another exemplary embodiment formed in accordance with the present invention, there is provided a vehicle including a hitch configured to couple to an implement. The hitch includes a frame, at least one linkage supported by the frame, and at least one latch pivotally connected to the frame and connected to the at least one linkage. The at least one latch has a distal end and a projection. The at least one latch is configured for selectively rotating between an engaged position for retaining the implement and a disengaged position for releasing the implement. The hitch also includes a mechanical stop connected to the frame and positioned adjacent to the projection in the engaged position of the at least one latch such that the mechanical stop is configured for preventing a deformation of the at least one linkage.

In yet another exemplary embodiment formed in accordance with the present invention, there is provided a hitch connectable to an implement. The hitch includes a frame, at least one linkage supported by the frame, and at least one latch pivotally connected to the frame and connected to the at least one linkage. The at least one latch has a distal end and a projection. The at least one latch is configured for selectively rotating between an engaged position for retaining the implement and a disengaged position for releasing the implement. The hitch also includes a mechanical stop connected to the frame and configured for preventing a deformation of the at least one linkage.

In yet another exemplary embodiment formed in accordance with the present invention, there is provided a hitch connectable to an implement. The hitch includes a frame having at least one slot with a slot floor and a stopping feature, at least one linkage supported by the frame, and at least one latch pivotally connected to the frame and connected to the at least one linkage. The at least one latch has a distal end and being configured for selectively rotating between an engaged position for retaining the implement in which the at least one latch at least partially extends out of the at least one slot and a disengaged position for releasing the implement in which the at least one latch is substantially positioned within the at least one slot. The distal end of the at least one latch acts as a mechanical stop by contacting the stopping feature in the engaged position upon the at least one latch receiving a load from the implement such that the stopping feature prevents a deformation of the at least one linkage.

One possible advantage of the exemplary embodiment of the agricultural vehicle is that the latches contacting the respective mechanical stops prevents the deformation of the linkages.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown Like numerals indicate like elements throughout the drawings. In the drawings:

FIG. 1 illustrates a side view of a known quick hitch;

FIGS. 2-3 illustrate perspective views respectively of the engaged and disengaged positions of the quick hitch as shown in FIG. 1;

FIGS. 4-5 illustrate perspective views of an embodiment of a quick hitch, in accordance with an exemplary embodiment of the present invention;

FIGS. 6-7 illustrate side cutaway views of the quick hitch as shown in FIGS. 4-5; and

FIG. 8 illustrates a perspective view of another embodiment of a quick hitch, in accordance with an exemplary embodiment of the present invention.

### DETAILED DESCRIPTION OF THE INVENTION

Referring now to FIGS. 1-3, there is shown a known embodiment of a three-point hitch coupler 10 for a vehicle, such as an agricultural vehicle in the form of a tractor. The hitch coupler 10 includes a frame 12 having a horizontal top bar 14 and a pair of vertical arms 16 attached thereto. The bottom of the arms 16 have hooks 18 which receive corresponding pins of the implement I that is coupled to the vehicle. The hitch coupler 10 can be in the form of a quick hitch coupler 10 which includes a quick latching feature for efficiently and selectively holding the pins of the implement I within the hooks 18. In this regard, the quick hitch coupler 10 may additionally include an actuation handle 20, a linkage 22, and a latch 24 associated with each hook 18 of each arm 16.

The handles 20 are typically positioned at the top of frame 12. The linkages 22 may be supported by the frame 12 and internally disposed within the body of the arms 16. The linkages 22 may interconnect the handles 20 to the latches 24. Each linkage 22 is in the form of a small diameter rod 22 composed of metal. The linkages 22 transmit the movement of the handles 20 to each latch 22. The latches 24 can be pivotally connected to the arms 16 of the frame 12 and may be at least partially enclosed within a respective slot 26 of each arm 16.

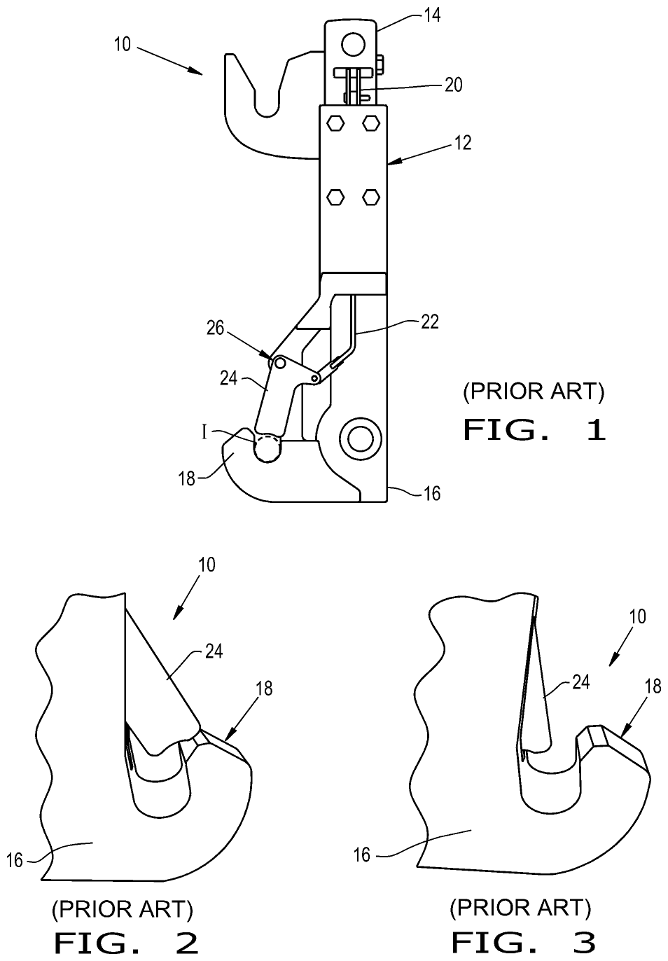

In operation, a user can selectively disengage or engage the implement I by actuating the handles 20 to move the linkages 22, which then correspondingly rotate the latches 24 between the engaged position (FIG. 2) and the disengaged position (FIG. 3). In the engaged position, the latches 24 obstruct the opening of the hooks 18 so that the implement I is held within the hooks 18. In the disengaged position, the latches 24 rotate to be substantially within the slots 26 of the arms 16 so the implement I can be readily removed from the hooks 18.

A linkage 22 may become bent when the pins of the implement I apply a substantially, vertically upward force or load onto a respective latch 24. In more detail, when the hitching pins of the implement I contact and apply force onto the latch 24, the force is transmitted through the latch 24 and onto the linkage 22, which typically bends or otherwise deforms the linkage 22 because the relatively small diameter of the linkage 22 cannot counteract the load acting upon it. A linkage 22 may then be permanently deformed which thereby causes the respective latch 24 to be overextended, as shown in FIGS. 2-3. For example, the respective deformed linkage 22 causes the latch 24 to not fully rotate back within the arm 16 and thus the latch 24 at least partially obstructs the opening of the hook 18 even though the latch 24 is in the disengaged position (FIG. 3).

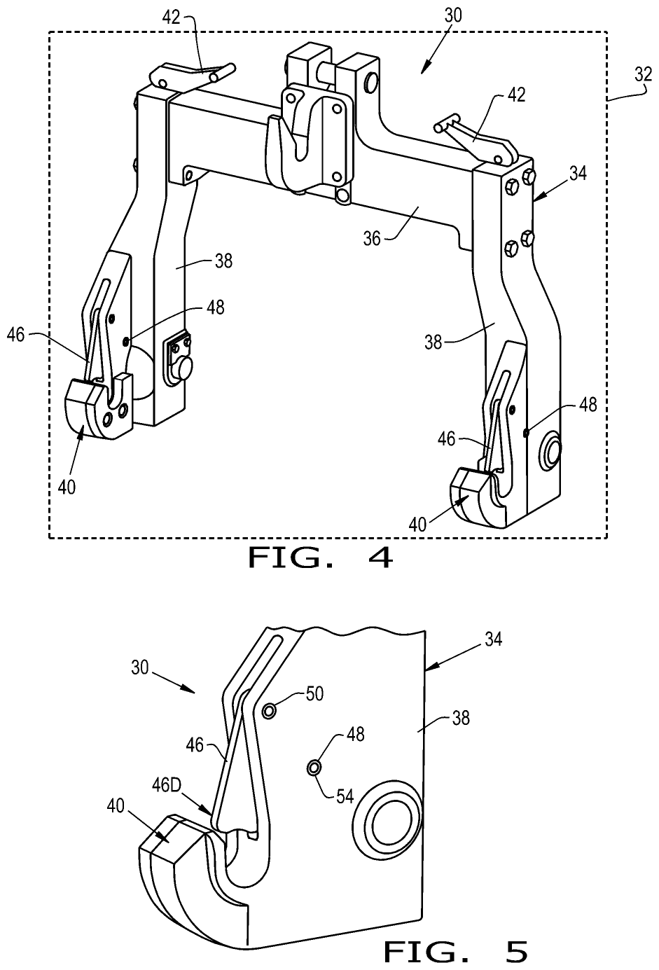

Referring now to FIGS. 4-7, there is shown an embodiment of a quick hitch coupler 30 in accordance with the present invention. The quick hitch coupler 30 may be incorporated into any desired vehicle 32. For example, the vehicle 32 may be an agricultural vehicle such as a tractor 32. The quick hitch coupler 30 is configured to selectively couple to an implement I. The quick hitch coupler 30 generally includes a frame 34 with a vertical bar 36 and at least one arm 38, such as a pair of arms 38, which each have a respective hook 40. The quick hitch coupler 30 also includes one or more hitching handle(s) 42, one or more linkage(s) 44, one or more latch(es) 46, and one or more mechanical stop(s) 48 (FIGS. 6-7). In the present embodiment, the quick hitch coupler 30 includes a respective pair of handles 42, linkages 44, latches 46, and mechanical stops 48. The quick hitch coupler 30 can be designed and function similarly to the hitch coupler 10 as described above except for the latches 46 and mechanical stops 48. Hence, the handles 42 can be actuated by an operator in order to correspondingly move the linkages 44 and thereby the latches 46 into and out the engaged position (FIG. 0.6) for retaining the implement I and the disengaged position for releasing the implement I (FIG. 7).

The latches 46 are configured for selectively rotating in and out of a designated slot (unnumbered) in the arms 38 to translate between the engaged position (FIG. 6) and the disengaged position (FIG. 7). The latches 46 are pivotally connected to the frame 34 and are respectively connected to each linkage 44. In more detail, each latch 46 is pivotally connected to the arms 38 via a pivot pin 50 and to the linkages 44 at pivot connection 52, which is located rearwardly of the pivot pin 50. Each latch 46 has a distal end 46D and a projection 46P (FIGS. 6-7). The projection 46P of each latch 46 may have a cross-section in the form of a hook 46P which extends downwardly and at least partially around the respective mechanical stop 48. Each projection 46P may be molded with or bent from each latch 46, or each projection 46P may be welded or bolted onto the latch 46. Each latch 46 also has a carve out 46C which correspondingly receives the mechanical stop 48 in the disengaged position (FIG. 7).

Each mechanical stop 48 is connected to the frame 34 and is configured for preventing a deformation of each respective linkage 44. The mechanical stop 48 is positioned relative to the projection 46P of the latch 46 so that when a vertically upward load, such as a substantially upward force “F” applied by the implement I, acting on the distal end 46D of a respective latch 46 the projection 46P will contact the mechanical stop 48, which then receives the load and prevents any of the load from transferring to a respective linkage 44 (FIG. 6). In other words, with reference to FIG. 6, the upward force F biases the latch 46 to rotate clockwise, but the projection 46P abutting against the mechanical stops 48 prevents latch 46 from rotating further, which would otherwise pull down and bend the linkage 44. Hence, as used herein a deformation of a linkage 44 refers to a bending of the original shape of the linkage 44 such that the linkage 44 then causes the respective latch 46 to interfere with the (dis)engagement of the implement I. Further, as used herein, the substantially upward force F may be defined as a vertically upward force within ±30 degrees. It should be appreciated that the mechanical stop 48 can be positioned relative to the projection 46P so that in the engaged position, the projection 46P already contacts the mechanical stop 48 or the mechanical stop 48 can be positioned approximately 2 mm, ±1 mm, away from the projection 46P.

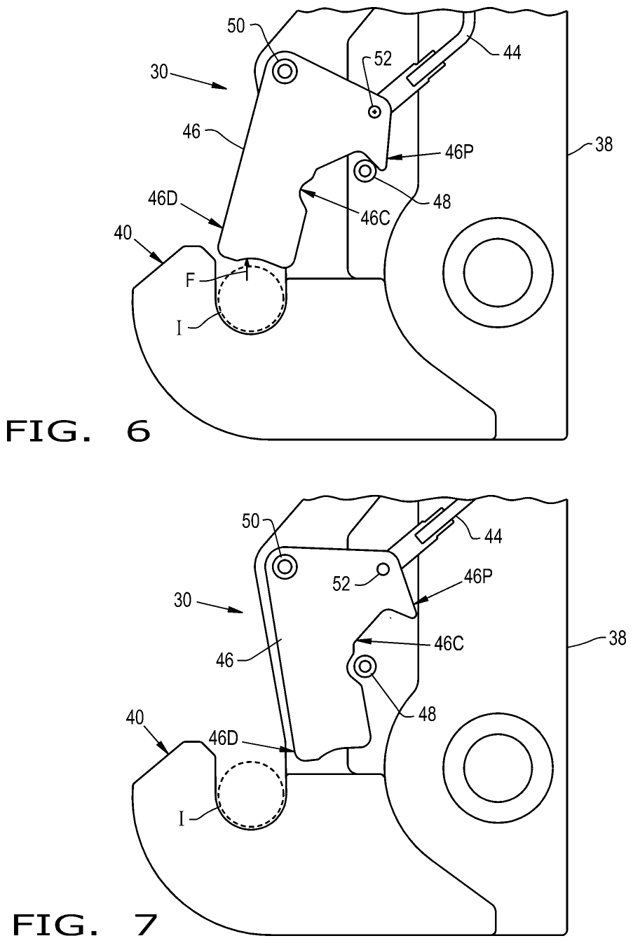

Each mechanical stop 48 can be in the form of a pin 48, such as a spring or roll pin, that is fitted into a corresponding hole 54 in the frame 34 (FIG. 5). Alternatively, the mechanical stop 48 may be in the form of a bolt disposed within the hole 54. The mechanical stop 48 could also be in the form of a feature that is molded with the frame 34 or welded onto the frame 34. It should be appreciated that the mechanical stop 48 also allows for greater accuracy during assembly in that the assembler can readily and consistently position the latch 46 relative to the mechanical stop 48.

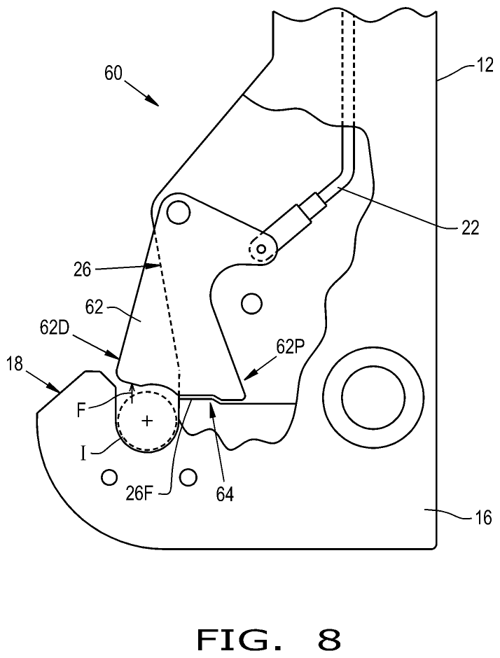

Referring now to FIG. 8, there is shown another embodiment of a hitch 60 which can be designed similarly to the hitch coupler 10 as discussed above, except the hitch 60 includes at least one latch 62 that is configured to engage with a stopping feature 64. Accordingly, like components have been identified with like reference characters.

Each latch 62 is pivotally connected to the frame 12 and connected to each linkage 22. The latches 62 rotate between the engaged position for retaining the implement I, in which the latches 62 at least partially extend out of the slots 26 and the disengaged position for releasing the implement I, in which the latches 62 are substantially positioned within the slots 26. Each latch 62 includes a distal end 62D which can have a first portion for extending out of the slot 26 and retaining the implement I and a second portion which may be in the form of a protrusion 62P for remaining substantially within the slot and contacting the stopping feature 64. Hence, a respective distal end 62D of a latch 62 acts as a mechanical stop by contacting the stopping feature 64 in the engaged position (FIG. 8) when the latch 62 receives a load, such as the substantially upward force F as described above, from the implement I. The distal ends 62D contacting the stopping features 64 prevent the load from transferring to the linkages 22. Thereby, the latches 62 and the stopping features 64 together prevent a deformation of the linkages 22. Each protrusion 62P may be integral with each latch 62 or each protrusion 62P may be welded or bolted onto each latch 62.

Each stopping feature 64 of each arm 16 can be in the form of the floor 26F of the slot 26 itself and/or the slot 26 can include a raised member which extends above the surface of the slot floor 26F. In other words, the slot floor 26F can be the stopping feature 64, the raised member can be the stopping feature 64, or the slot floor 26F in conjunction with the raised member can collectively be the stopping feature 64. The stopping feature 64 can be integral with the slot floor 26F so that the distal end 62D of each latch 62 contacts the slot floor 26F itself and/or the raised member of the slot floor 26F. Alternatively, if the stopping feature 64 is designed as a separate component, such as a plate, the stopping feature 64 may be welded and/or bolted onto the slot floor 26F.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A vehicle, comprising:
a hitch configured to couple to an implement, the hitch including;
a frame;
at least one linkage supported by the frame;
at least one latch pivotally connected to the frame and connected to the at least one linkage, the at least one latch having a distal end and a projection, the at least one latch is configured for selectively rotating between an engaged position for retaining the implement and a disengaged position for releasing the implement; and
a mechanical stop connected to the frame and positioned adjacent to the projection in the engaged position of the at least one latch such that the mechanical stop is configured for preventing a deformation of the at least one linkage.

2. The vehicle of claim 1, wherein in the engaged position, the projection of the at least one latch contacts the mechanical stop upon the at least one latch receiving a load from the implement so that the mechanical stop receives the load acting on the at least one latch and prevents the load from transferring to the at least one linkage.

3. The vehicle of claim 2, wherein the load from the implement is in the form of a substantially upward force from the implement applied to the distal end of the at least one latch in the engaged position.

4. The vehicle of claim 2, wherein the at least one latch includes a carve out which correspondingly receives the mechanical stop in the disengaged position.

5. The vehicle of claim 1, wherein the frame of the hitch has a hole and the mechanical stop is in the form of a pin which is disposed within the hole.

6. The vehicle of claim 1, wherein the protrusion of the at least one latch has a cross-section in the form of a hook, and the protrusion extends downwardly and at least partially around the mechanical stop.

7. The vehicle of claim 1, wherein the hitch further includes a pair of hitch arms which each include a hook, the at least one linkage is in the form of two linkages, and the at least one latch is in the form of two latches such that the distal ends of each latch selectively obstruct the hooks of the hitch arms for retaining the implement in the engaged position.

8. A hitch connectable to an implement, comprising:
a frame;
at least one linkage supported by the frame;
at least one latch pivotally connected to the frame and connected to the at least one linkage, the at least one latch having a distal end and a projection, the at least one latch is configured for selectively rotating between an engaged position for retaining the implement and a disengaged position for releasing the implement; and
a mechanical stop connected to the frame and configured for preventing a deformation of the at least one linkage.

9. The hitch of claim 8, wherein in the engaged position, the projection of the at least one latch contacts the mechanical stop upon the at least one latch receiving a load from the implement so that the mechanical stop receives the load acting on the at least one latch and prevents the load from transferring to the at least one linkage.

10. The hitch of claim 9, wherein the load from the implement is in the form of a substantially upward force from the implement applied to the distal end of the at least one latch in the engaged position.

11. The hitch of claim 9, wherein the at least one latch includes a carve out which correspondingly receives the mechanical stop in the disengaged position.

12. The hitch of claim 8, wherein the frame of the hitch has a hole and the mechanical stop is in the form of a pin which is disposed within the hole.

13. The hitch of claim 8, wherein the protrusion of the at least one latch has a cross-section in the form of a hook, and the protrusion extends downwardly and at least partially around the mechanical stop.

14. The hitch of claim 8, further including a pair of hitch arms which each include a hook, the at least one linkage is in the form of two linkages, and the at least one latch is in the form of two latches such that the distal ends of each latch selectively obstruct the hooks of the hitch arms for retaining the implement in the engaged position.

15. A hitch connectable to an implement, comprising:
a frame having at least one slot with a slot floor and a stopping feature;
at least one linkage supported by the frame;
at least one latch pivotally connected to the frame and connected to the at least one linkage, the at least one latch having a distal end and being configured for selectively rotating between an engaged position for retaining the implement in which the at least one latch at least partially extends out of the at least one slot and a disengaged position for releasing the implement in which the at least one latch is substantially positioned within the at least one slot, the distal end of the at least one latch acts as a mechanical stop by contacting the stopping feature in the engaged position upon the at least one latch receiving a load from the implement such that the stopping feature prevents a deformation of the at least one linkage.

16. The hitch of claim 15, wherein the load from the implement is in the form of a substantially upward force from the implement applied to the distal end of the at least one latch in the engaged position, and the distal end contacting the stopping feature prevents the load from transferring to the at least one linkage.

17. The hitch of claim 15, wherein the stopping feature is integral with the slot floor so that the distal end of the at least one latch contacts the slot floor.

18. The hitch of claim 15, wherein the stopping feature is in the form of a raised member extending above a surface of the slot floor.

19. The hitch of claim 15, wherein the distal end of the at least one latch has a first portion for extending out of the at least one slot and a second portion in the form of a protrusion for contacting the stopping feature in the engaged position.

20. The hitch of claim 15, further including a pair of hitch arms which each include a hook, the at least one linkage is in the form of two linkages, and the at least one latch is in the form of two latches such that the distal ends of each latch selectively obstruct the hooks of the hitch arms for retaining the implement in the engaged position.
